(19) United States
(12) Patent Application Publication
(10) Pub. No.: US 2007/0075253 A1
(43) Pub. Date: Apr. 5, 2007

(54) X-ray imaging device and X-ray CT apparatus

(75) Inventors: Takeshi Misawa, Saitama (JP); Masayuki Hayashi, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: FUJI PHOTO FILM CO., LTD., Minami-Ashigara-shi (JP)

(21) Appl. No.: 11/528,423

(22) Filed: Sep. 28, 2006

(30) Foreign Application Priority Data
Sep. 30, 2005 (JP) P2005-288863

(51) Int. Cl. G01T 1/20

(52) U.S. Cl. 250/370.11; 250/370.09

(57) ABSTRACT

An X-ray imaging device is provided and has a scintillator and an imaging device in combination. The scintillator receives an X-ray through a subject to emit fluorescence, and the imaging device receives the fluorescence. The scintillator has a curved shape, and the imaging device has a substrate having flexibility and is positioned opposite to the scintillator.

### BACKGROUND OF THE INVENTION

1. Field of the Invention

The present invention relates to an X-ray imaging device in which the scintillator for converting an X-ray into a visible light, or the like and the imaging devices for receiving the visible light, or the like are used in combination, and an X-ray CT apparatus using the same.

2. Description of Related Art

As the X-ray imaging device for capturing an image by visualizing an X-ray, there are some devices that can sense directly an X-ray and others that can visualize an X-ray by using the scintillator and then capture an image by using the imaging device such as CCD, or the like, as set forth in JP-A-5-152597, JP-A-6-214036, JP-A-11-151235, JP-A-2000-56028 and JP-A-2003-17676, for example.

When the X-ray computed tomography (CT) apparatus is constructed by using the scintillator and the imaging device in combination, the configuration shown in FIG. 14, for example, is employed in the prior art. More particularly, a circular opening portion 4 into which a subject 3 on a stretcher 2 is carried is provided to a center of a main body of an X-ray CT apparatus 1. An X-ray irradiator 5 for irradiating an X-ray onto the subject 3, an X-ray imaging device (having a scintillator and an imaging device) 6 for receiving the X-ray transmitted through the subject 3, a driving mechanism (not shown) for causing the X-ray irradiator 5 and the X-ray imaging device 6 to turn integrally around the circular opening portion 4, and a transfer unit 7 for transferring the captured image of the subject 3 output from the X-ray imaging device 6 to the outside are provided to the X-ray CT apparatus 1.

In the X-ray CT apparatus 1 shown in FIG. 14 in the related art, the X-ray imaging device 6 is shaped like a flat plate. Therefore, a size of the X-ray CT apparatus 1 is defined depending upon a size of the X-ray imaging device 6, and thus it is unfeasible to achieve a size reduction much more.

If the X-ray imaging device 6 can be provided to curve along an outer periphery of the center opening portion 4, the X-ray CT apparatus 1 can be reduced in size. Therefore, if an X-ray imaging device 6a can be constructed by aligning the scintillators and the imaging devices, which are prepared as a small piece respectively, in a curved fashion as shown in FIG. 15, a reduction in size of the X-ray CT apparatus 1 can be attained.

In this event, the scintillator out of the X-ray imaging device 6a can be shaped easily into the small pieces, but it is difficult to cut the imaging device into small pieces. For example, although it is possible to manufacture a large number of small imaging devices and construct one large imaging device by aligning them, it is hard to make the characteristics of a large number of imaging devices uniform. Thus, the need to apply the correction of sensitivity, sensitivity offset, etc. to individual imaging devices with high precision arises. For this reason, employment of the configuration in FIG. 15 is at a disadvantage in cost.

### SUMMARY OF THE INVENTION

An object of an illustrative, non-limiting embodiment of the invention is to provide an X-ray imaging device and an X-ray CT apparatus, which can employ curved imaging device and can be manufactured inexpensively.

According to one aspect of the invention, there is provided an X-ray imaging device in which a scintillator receiving an X-ray through a subject to emit fluorescence and an imaging device receiving the fluorescence are employed in combination. The scintillator has a curved shape, and the imaging device has a substrate having flexibility and is positioned opposite to the scintillator.

In one aspect of the invention, the imaging device has a shape along a surface of the scintillator.

In one aspect of the invention, the imaging device has a photosensitive layer containing an organic material that photoelectrically converts an incident light.

In one aspect of the invention, the scintillator and the photosensitive layer are formed of respective materials such that a peak wavelength of the fluorescence emitted from he scintillator coincides, in a wavelength range, with a peak wavelength of a photo sensitivity of the photosensitive layer.

According to one aspect of the invention, there is provided an X-ray CT apparatus including: an X-ray irradiator for irradiating a subject with an X-ray; an X-ray imaging device according to one aspect of the invention, positioned opposite to the X-ray irradiator via the subject; and a driving unit for turning integrally the X-ray irradiator and the X-ray imaging device around the subject in such a state that the X-ray irradiator and the X-ray imaging device are opposed to each other.

### BRIEF DESCRIPTION OF THE DRAWINGS

The features of the invention will appear more fully upon consideration of the exemplary embodiments of the inventions, which are schematically set forth in the drawings, in which:

FIG. 1 is a configurative view of an X-ray CT apparatus according to an exemplary embodiment of the present invention;

FIG. 2 is a schematic view of an X-ray imaging device shown in FIG. 1, a part of which is shown in an enlarged unpackaged manner;

FIG. 3 is a schematic sectional view taken along a III-III line in FIG.2;

FIG. 4 is an explanatory view of a detailed section of a photosensitive layer;

FIG. 5 is an explanatory view of a detailed section of another photosensitive layer;

FIGS. 6A and 6B are views showing spectral sensitivity and a structural formula of copper phthalocyanine;

FIGS. 7A and 7B are views showing spectral sensitivity and a structural formula of porphyrin;

FIGS. 8A and 8B are views showing spectral sensitivity and a structural formula of Me-PTC;

FIGS. 9A and 9B are views showing spectral sensitivity and a structural formula of quinacridone;

FIGS. 10A and 10B are views showing spectral sensitivity and a structural formula of Alq;

FIG. 11 is a table showing a material correspondence between the scintillator and the imaging device (its photosensitive layer);

FIG. 12 is a configurative view of a high-speed readable X-ray imaging device in another exemplary embodiment instead of FIG. 2.

FIG. 13 is an explanatory view of an example of an apparatus in which an organic imaging device is formed on a surface of the scintillator.

FIG. 14 is an explanatory view of an X-ray CT apparatus in the related art.

FIG. 15 is an explanatory view of an X-ray CT apparatus of the improved type in FIG. 14.

### DETAILED DESCRIPTION OF THE EXEMPLARY EMBODIMENTS

Although the invention will be described below with reference to the exemplary embodiments thereof, the following exemplary embodiments and modifications do not restrict the invention.

According to exemplary embodiments, an X-ray imaging device and an X-ray CT apparatus that are small in size and low in cost can be provided since the imaging device is shaped into a curved form.

Exemplary embodiments of the present invention will be explained with reference to the drawings hereinafter.

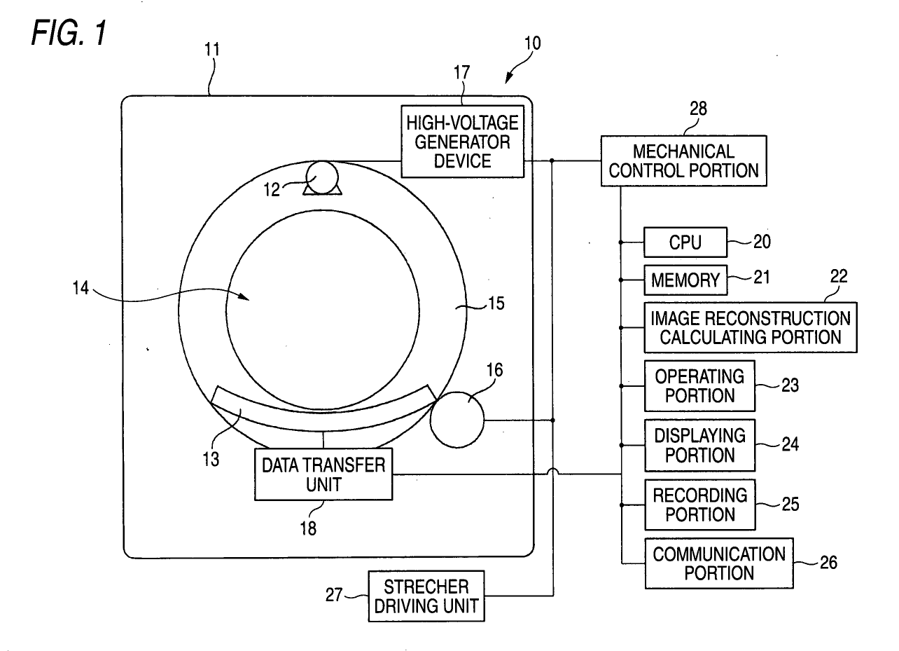

FIG. 1 is a configurative view of an X-ray CT apparatus according to an exemplary embodiment of the present invention. An X-ray CT apparatus 10 includes a main body 11 of the apparatus, an X-ray irradiator 12 provided in the main body 11 of the apparatus, an X-ray imaging device 13 opposite to the X-ray irradiator 12 and formed to be curved, a frame 15 for causing the X-ray irradiator 12 and the X-ray imaging device 13 to turn together around a center opening portion 14, a frame driving portion 16 for driving the frame 15 to turn, a high-voltage generator device 17 for supplying a high voltage to the X-ray irradiator 12 via a slip ring, and a data transfer unit 18 for transferring X-ray captured image data output from the X-ray imaging device 13.

This X-ray CT apparatus 10 further includes a CPU 20 for controlling the overall X-ray CT apparatus 10, a memory 21, an image reconstruction calculating portion 22, an operating portion 23, a displaying portion 24 for displaying the X-ray captured image data sent from the data transfer unit 18, a recording portion 25 for recording the captured image data, a communicating portion 26, a stretcher driving unit 27, and a mechanical control portion 28 for controlling the high-voltage generator device 17, the frame driving portion 16, and the stretcher driving unit 27.

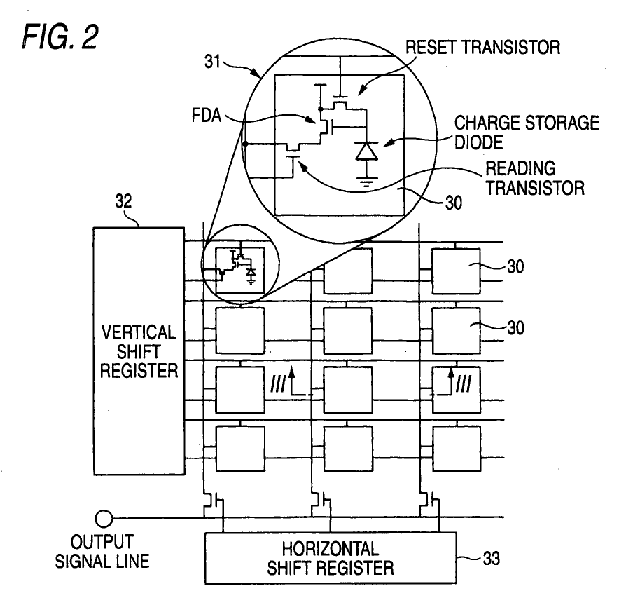

FIG. 2 is a schematic view of an X-ray imaging device shown in FIG. 1, a part of which is shown in an enlarged unpackaged manner. In an illustrated example, a large number of pixels 30 are aligned in a rectangular matrix fashion on a surface of the X-ray imaging device 13, and a signal reading circuit 31 for reading an image signal in response to a topography of the subject sensed by respective pixels 30 is formed on bottom portions of respective pixels 30.

In the present embodiment, a signal reading circuit constructed by three transistors used in the CMOS image sensor is shown as an example of the signal reading circuit 31, but a signal reading circuit constructed by four transistors may be employed. When the signal reading circuit corresponding to the pixel from which the pixel signal is to be read is designated by a vertical shift register 32 and a horizontal shift register 33, an image signal is output from the X-ray imaging device 13 to the data transfer unit 18.

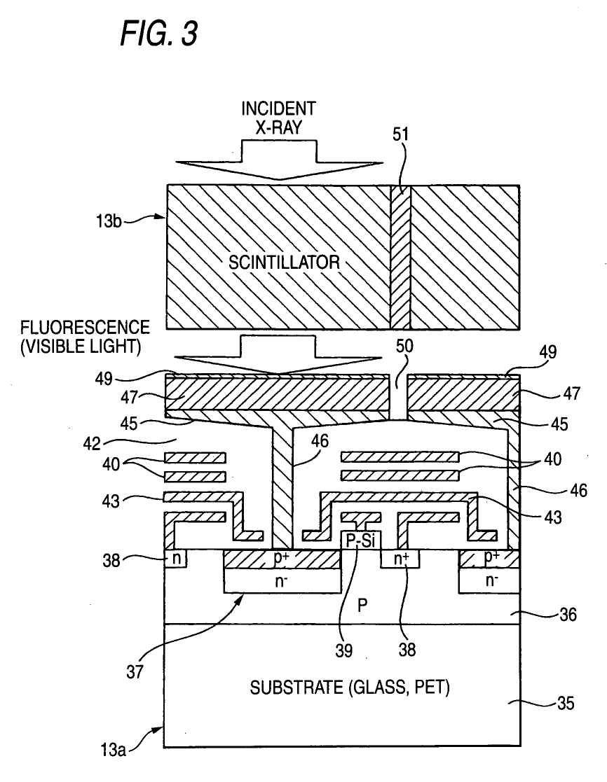

FIG. 3 is a schematic sectional view taken along a III-III line in FIG. 2, which corresponds to a section of almost 1.5 pixel. The X-ray imaging device 13 in the present embodiment consists of an imaging device 13a and a scintillator 13b arranged over the imaging device 13a.

The imaging device 13a is formed on a flexible substrate 35. As the flexible substrate 35 used in the present embodiment, a glass substrate that can be formed thin and be curved or a flexible sheet formed by shaping the material such as polyethylene terephthalate (PET), or the like into a sheet is employed.

Then, a p-type semiconductor layer 36 is formed on a surface of the flexible substrate 35. A diode portion explained later, the signal reading circuit 31, and the like are formed on the semiconductor layer 36 by using the technology to manufacture the TFT matrix on the liquid crystal substrate, or the like, as set forth in JP-A-5-158070, for example, or the technology to manufacture the organic EL device, or the like.

First, a diode portion 37 serving as a signal charge storage region is formed in locations on the surface portion of the semiconductor layer 36 respectively. Also, an n⁺-region 38 constituting a part of the transistor of the signal reading circuit 31 is formed on the surface portion of the semiconductor layer 36. When a reading voltage is applied to a gate electrode 39 provided via a surface oxide layer (not shown) of the semiconductor layer 36, accumulated charges in the diode portions 37 are moved to the n⁺-region 38 and then read out to the outside of the X-ray imaging device 13 by the signal reading circuit 31 (FIG. 2).

The signal reading circuit 31 is shielded from a light by a light shielding layer 43 that is buried in an insulating layer 42 stacked on the surface portion of the semiconductor layer 36. Wiring layers 40 for connecting the signal reading circuit 31 to the vertical shift register 32 and the horizontal shift register 33 in FIG. 2 are provided on the light shielding layer 43 and in the insulating layer 42. Pixel electrode layers 45 are stacked on a surface of the insulating layer 42, and vertical wirings 46 for connecting the pixel electrode layers 45 and the diode portions 37 are provided upright. Then, photosensitive layers (photoelectric converting layers) 47 that are sensitive to fluorescence emitted from the scintillator are stacked on the pixel electrode layers 45, and then a transparent opposing electrode layer 49 is stacked thereon. The imaging device 13a includes respective members from the flexible substrate 35 to the opposing electrode layer 49.

In the present embodiment, a clearance (space) 50 for isolating adjacent photosensitive layers 47 (the electrode layers 45, 49) from each other is provided between the pixels at appropriate locations, and also a flexibility of the imaging device manufactured on the flexible substrate 35 is improved further. Thus, the X-ray imaging device 13 can be curved as shown in FIG. 1, and then can be arranged easily in the frame 15 of the X-ray CT apparatus. In this case, if a curvature to be curved is small and a radius of curvature is large, the clearance 50 is not always needed.

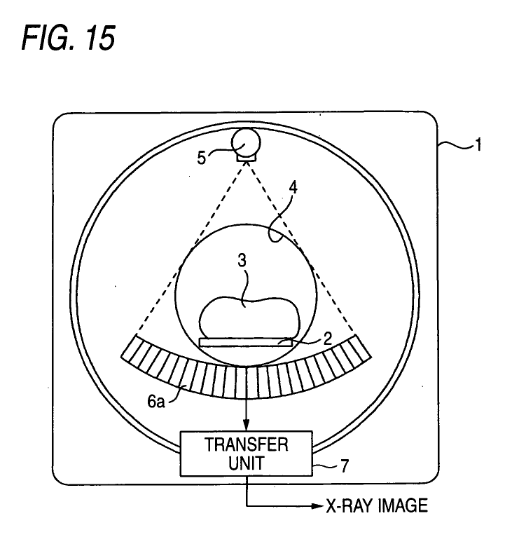

In the present embodiment, a separator 51 is inserted into the scintillator 13b, which is arranged over the imaging device 13a, between respective pixels not to lower a resolution of the captured image data. Since the scintillator 13b is basically made of a machinable ceramic substance, such scintillator is depicted as a rectangular prism in FIG. 3. Actually the-scintillator 13b is shaped into a form whose upper area is slightly narrowed, and such scintillator is shaped into a curved form as a whole. As explained in FIG. 15, the scintillator 13b may be constructed by arranging the scintillators prepared as the small pieces in a curved shape.

In the X-ray CT apparatus using the X-ray imaging device 13 constructed as above, when the tomogram of the subject on the stretcher (not shown) should be captured, the X-ray irradiator 12 and the X-ray imaging device 13 are turned (scanned) while moving the stretcher in the center opening portion of the main body 11 of the X-ray CT apparatus 10.

The X-ray irradiated from the X-ray irradiator 12 to the subject is passed through the subject and is incident on the scintillator 13b. Then, the fluorescence is generated in response to a transmitted dose of the X-ray. When this fluorescence is incident into the imaging device 13a, an incident light is photoelectric-converted by the photosensitive layers (organic photoelectric converting layers) 47 (FIG. 3) and thus the hole-electron pairs are generated.

A voltage is applied to the photosensitive layers 47 between the pixel electrode layers 45-the the opposing electrode layer 49, as the case may be. A potential gradient is generated in the photosensitive layers 47 by this voltage, and the electrons out of the hole-electron pairs are moved to the pixel electrode layers 45 along this potential gradient. Then, the electrons flow through the vertical wirings 46 to the diode portions 37, and then the electrons are stored in the diode portions 37.

In the example illustrated in FIG. 3, the diode portions 37 are provided as the buried type such that these portions are not subjected to the influence of the lattice defect on the boundary. But a mere diode (capacitor) may be employed.

A charge storage timing applied to the diode portions 37 can be decided by either a voltage application to the photosensitive layers 47 or a resetting of the diode portions 37. In order to synchronize this charge storage timing with a scanning timing, desirably the method of reading the signal based on the MOS switching by executing sequentially steps of
(1) applying a high voltage to the photosensitive layers prior to the scan to discharge excess charges from the photosensitive layers,
(2) resetting the diode portions 37,
(3) applying a voltage to the photosensitive layers to generate a potential gradient, and
(4) starting the X-ray irradiation and starting the scan, should be employed.

The charges stored in the diode portions 37 are read out to a floating diffusion amplifier (FDA) via a gate of a reading transistor in the signal reading circuit, and converted into a voltage. The signal can be output every pixel by reading the converted voltage. Also, the stored charges can be reset prior to the signal reading, as occasion demands (which is similar to the normal CMOS image sensor driving method).

In this case, the X-ray imaging device 13 can be slightly inclined from the slice direction in response to a moving speed of the stretcher and a turning speed of the scan. At that time, conveniently the spiral image data can be derived without stop of the stretcher.

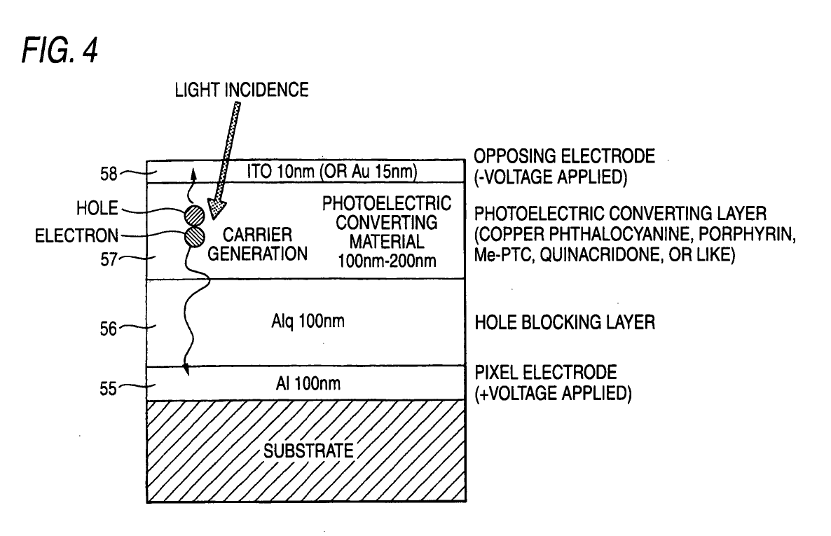

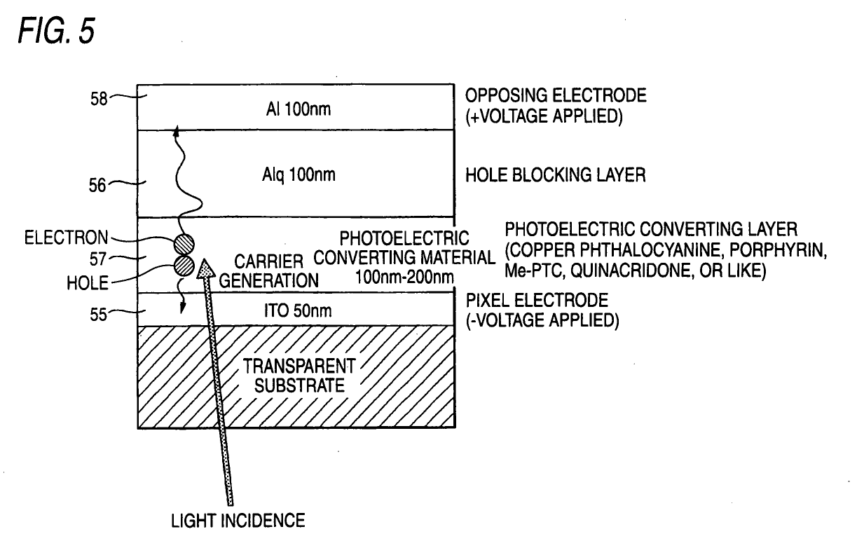

FIG. 4 is an explanatory view of a detailed section of the photosensitive layer. In FIG. 3, the photosensitive layer is explained as the structure in which the photosensitive layer is put between the pixel electrode layer and the opposing electrode layer. But actually the structure illustrated in FIG. 4 should be employed preferably. Also, FIG. 4 shows the example in which a light is incident from the opposite side to the substrate, while the case where a light is incident from the substrate side when a transparent substrate is employed is shown in FIG. 5. Because explanations of the material and others are similar in both FIG. 4 and FIG. 5, explanation will be made of FIG. 4 only hereunder. Here, the diode portion, the vertical wiring, the signal reading circuit, the light shielding layer, and the like are omitted from FIG. 4 and FIG. 5.

In FIG. 4, a hole blocking layer 56 is formed of Alq on a pixel electrode layer 55 (“45” in FIG. 3) made of a thin aluminum, then a photosensitive layer 57 (“47” in FIG. 3) is formed by stacking photoelectric converting materials thereon, and then a transparent opposing electrode layer 58 (“49” in FIG. 3) is formed of ITO or Au thereon.

Layers of the aluminum, the photoelectric converting materials, and Alq can be formed respectively by the vacuum deposition. A degree of vacuum should be set preferably to almost 10⁻⁴ Pa. When a voltage is applied between the pixel electrode layer 55 and the opposing electrode layer 58, a dark current caused by the injection of holes becomes large particularly and thus Alq is needed as the hole blocking layer 56.

The hole blocking layer 56 receives the electron carrier generated in the photosensitive layer (photoelectric converting layer) 57 and transports the electron carrier to the pixel electrode layer 55, while preventing the hole injection from the pixel electrode layer 55. Also, the hole blocking layer 56 has sensitivity although such sensitivity is small.

The opposing electrode (ITO, Au, or the like) 58 can be formed by the sputter, the electron beam deposition, the ion plating, or the like. In the case where an organic layer is employed as the photosensitive layer 57, normally a yield is extremely degraded due to a short-circuit when the ITO 58 is formed on the organic layer 57. In this case, when a thickness of ITO is set to almost 10 nm or less, a yield can be improved.

When the ITO heavily damages the organic layer 57, a thin layer of gold (Au) may be employed as the opposing electrode layer 58 although a light transmittance of Au is smaller than ITO. In this case, it is also desired that a thickness of Au is set to almost 15 nm or less.

When the photosensitive layer 57 has a thickness of about 100 nm, such photosensitive layer 57 can absorb 90 to 99% of an incident light including a reflection from the aluminum electrode layer 55. An applied voltage between the pixel electrode layer 55 and the opposing electrode layer 58 is set normally to almost 1 V to 30 V, and an external quantum efficiency at a maximum absorption wave is about 20 to 40% at the applied voltage of about 15 V. When the applied voltage is increased further more, a quantum efficiency can be increased but a S/N ratio is decreased because a dark current due to the carrier injection from the pixel electrode layer 55 is increased.

Since the photoelectric converting layer 57 formed of the organic material is deteriorated by an oxygen or a moisture, a sealing layer made of a silicon nitride, or the like must be formed on the opposing electrode layer 58 (in FIG. 3, the opposing electrode layer 59). At that time, the sealing layer should be formed by the low-damage sputter, the low-damage plasma CVD, or the like not to do the damage to the device.

As the material of the photosensitive layer 57 (“47” in FIG. 3), copper phthalocyanine, porphyrin, Me-PTC, quinacridone, or the like may be cited.

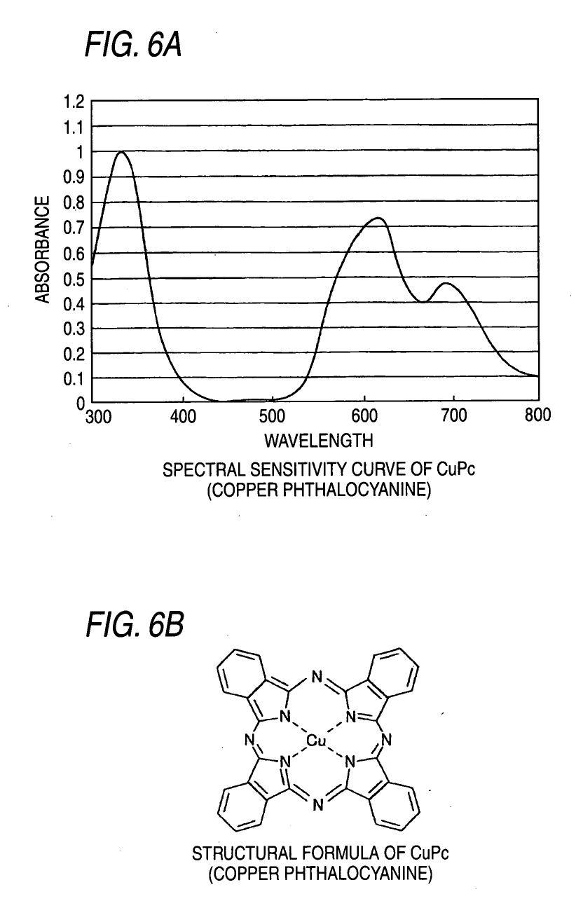

FIG. 6A shows the absorbance characteristic of CuPc (copper phthalocyanine), and FIG. 6B shows the structural formula of CuPc. Because the “absorption” means the occurrence of “charge-conversion”, FIG. 6A is equivalent to the spectral sensitivity characteristic of CuPc. When the spectral sensitivity is viewed, the copper phthalocyanine also has a peak around a wavelength 620 nm. This copper phthalocyanine may be combined with the scintillator material whose maximum peak coincides with a luminous wavelength of the scintillator.

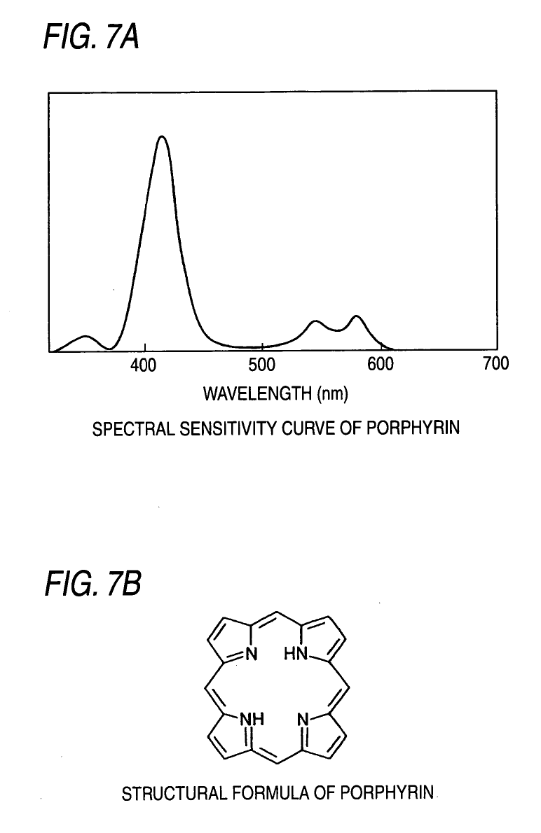

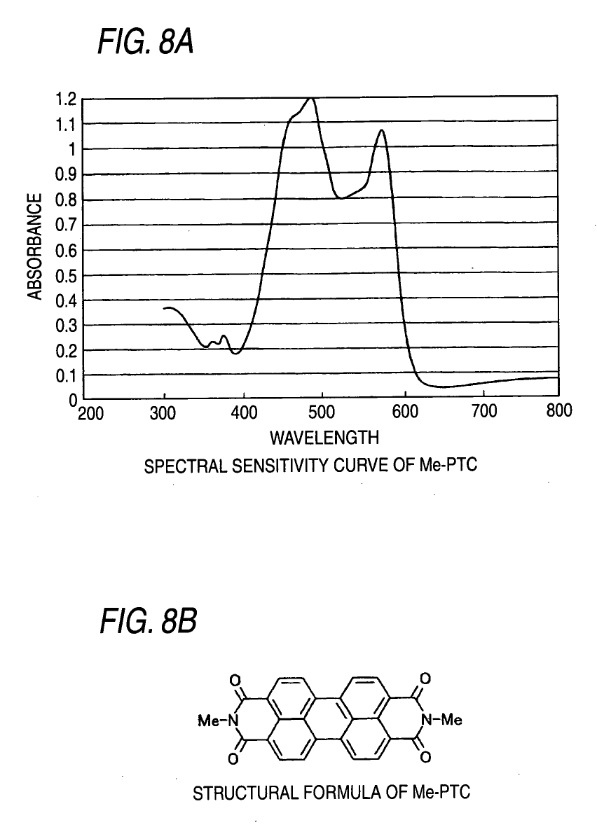

FIG. 7A is the spectral sensitivity characteristic of porphyrin, and FIG. 7B is the structural formula of porphyrin. FIG. 8A is the spectral sensitivity characteristic of Me-PTC (methyl PTC), and FIG. 8B is the structural formula of Me-PTC.

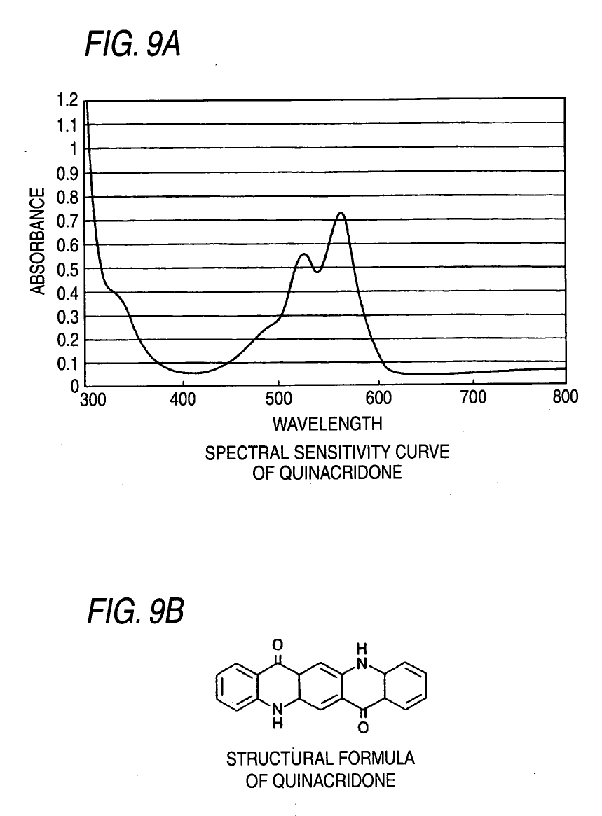

FIG. 9A is the spectral sensitivity characteristic of quinacridone, and FIG. 9B is the structural formula of quinacridone. The quinacridone also has a sensitivity peak at a short wavelength (<300 nm). This quinacridone may be combined with the scintillator material whose luminous wavelength is around 560 nm.

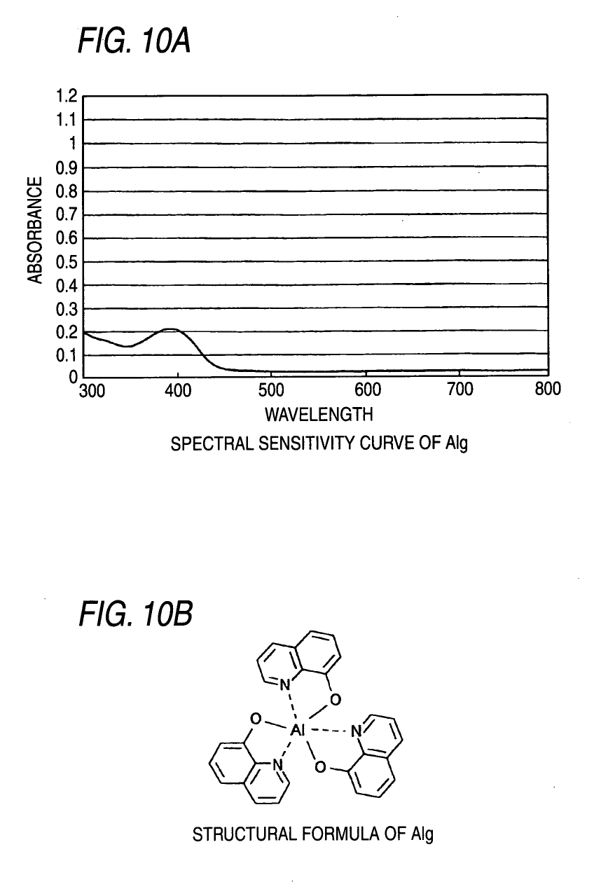

The Alq used as the hole blocking layer has sensitivity. FIG. 10A is the spectral sensitivity characteristic of Alq, and FIG. 10B is the structural formula of Alq. When Alq is combined with CuPc or porphyrin, this Alq contributes particularly to the sensitivity.

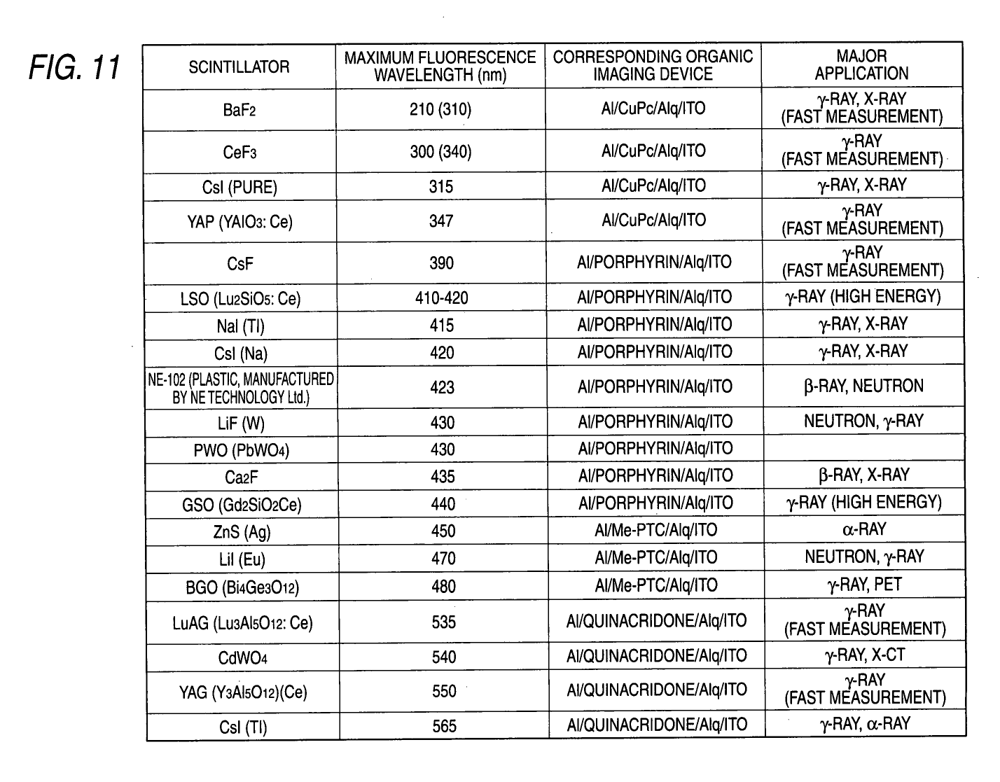

FIG. 11 is a table showing a combination correspondence between the material of the scintillator 13b and the material constituting the imaging device. Combinations used for applications to sense γ-ray, α-ray, and the like are also illustrated together in Table. In this case, it is understood that six type combinations as below are available for the X-ray application:
(BaF₂)-(Al/CuPc/Alq/ITO);
(CsI(Pure))-(Al/CuPc/Alq/ITO);
(NaI(TI))-(Al/porphyrin/Alq/ITO);
(CsI(Na))-(Al/porphyrin/Alq/ITO);
(CaF₂(Eu))-(Al/porphyrin/Alq/ITO); and
(CdWO₄)-(Al/quinacridone/Alq/ITO).

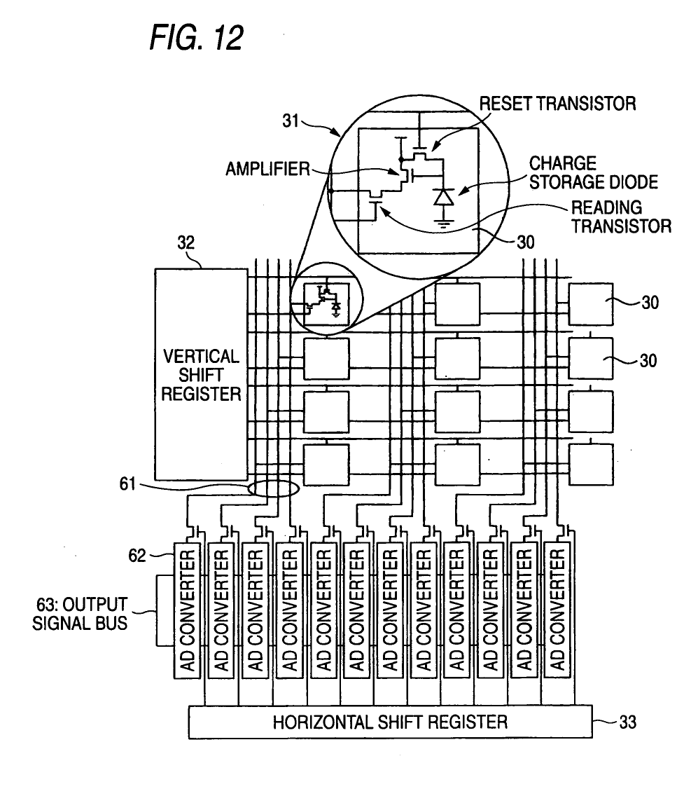

In the X-ray CT apparatus, the number of image data to be processed becomes huge. Therefore, it is preferable that, when the number of pixels is increased much more, the image data must be read from the X-ray imaging device 13 at a higher speed and then output to the image reconstruction calculating portion 22 (FIG. 1). A configuration of the X-ray imaging device 13 aiming at a high-speed reading is shown in FIG. 12.

The parallel reading is effective to accelerate a reading speed of the signal reading circuit constructed by CMOS circuits. Therefore, in the embodiment shown in FIG. 12, the number of signal reading lines 61 (the vertical reading lines in FIG. 12) of the signal reading circuits are increased rather than the embodiment shown in FIG. 2 such that the image can be read simultaneously from four pixels in the vertical direction.

Also, when the number of signal reading lines 61 is increased, the number of output signal lines is also increased in proportion to that number. Therefore, the output signals are converted into digital signals by AD converters 62, and then the multiple digital signals are read into an output signal bus 63, so that the number of output signal lines is reduced. The parallel bus may be employed as the output signal bus 63, but the number of output signal lines can be reduced further when the serial bus is employed as the output signal bus.

In the X-ray imaging device explained in FIG. 3, such a configuration is employed that the scintillator 13b and the imaging device 13a are manufactured separately and then they are combined together. In this case, the scintillator can be shaped into a curved form and then the imaging device can be formed on a surface of the scintillator.

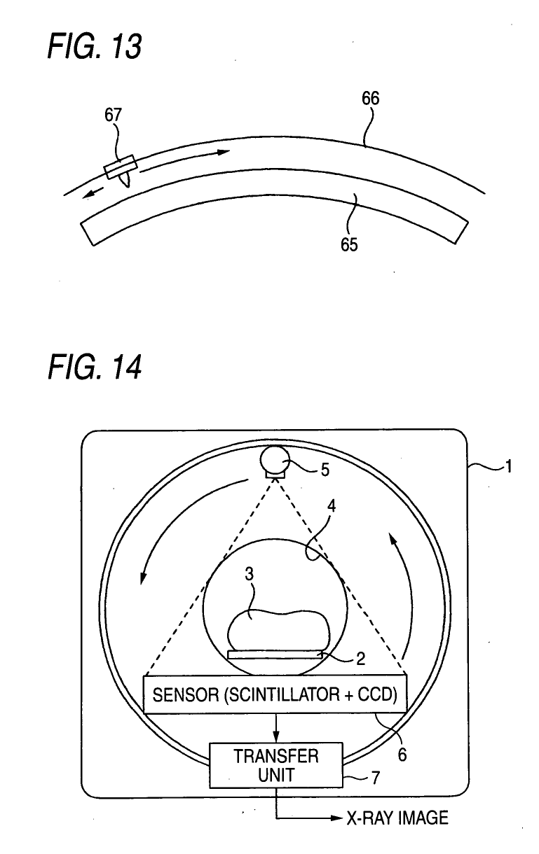

FIG. 13 is a view showing an outline of a manufacturing apparatus used when the imaging device is formed on a surface of the curved scintillator. A rail 66 curved along a surface of a curved scintillator 65 is provided to this manufacturing apparatus. Also, an applicator (e.g., ink jet) 67 moved along the rail 66 to apply an organic photosensitive layer, or the like on a surface of the scintillator 65 is provided.

In this manner, when the imaging device is formed by applying the organic photosensitive layer, or the like on the surface of the scintillator, smoothness of the surface of the scintillator becomes an issue. Here, ceramics of the scintillator material can attain smoothness of its surface to a considerable extent, so that the imaging device can be manufactured. Also, when this smoothness is not enough, the surface treatment may be applied to polish the surface of the scintillator or coat PET or glass material on the surface.

Then, when the smooth surface can be completed, the photosensitive layer, the electrode layer, the insulating layer, and the like are stacked on this surface and then the signal reading circuit is manufactured finally. For example, this signal reading circuit may be provided by taking the signal reading circuit manufactured on the semiconductor substrate off the semiconductor substrate as a thin layer and then pasting this signal reading circuit onto the scintillator. Alternately, the signal reading circuit may be manufactured on the thin semiconductor layer formed on PET, or the like, and then such signal reading circuit may be pasted on the scintillator. Accordingly, the imaging device with the integrated scintillator (=the X-ray imaging device) can be formed.

In the X-ray imaging device of the above embodiment, the signal reading circuit consisting of a three-transistor arrangement or a four-transistor arrangement used in the CMOS image sensor in the prior art is employed as the signal reading means. It is needless to say that the configuration using the charge transferring path in the CCD image sensor in the prior art may be employed as the signal reading means.

An aspect of the present invention is useful to an X-ray imaging device using the scintillator because a reduction in size and cost can be attained easily.

While the invention has been described with reference to the exemplary embodiments, the technical scope of the invention is not restricted to the description of the exemplary embodiments. It is apparent to the skilled in the art that various changes or improvements can be made. It is apparent from the description of claims that the changed or improved configurations can also be included in the technical scope of the invention.

This application claims foreign priority from Japanese Patent Application No. 2005-288863, filed Sep. 30, 2005, the entire disclosure of which is herein incorporated by reference.

What is claimed is:

1. An X-ray imaging device comprising:
a scintillator that receives an X-ray through a subject to emit fluorescence and has a curved shape; and
an imaging device that receives the fluorescence and converts the fluorescence into an electric signal, comprises a substrate having flexibility, and is positioned opposite to the scintillator.

2. The X-ray imaging device according to claim 1, wherein the imaging device has a shape along a surface of the scintillator.

3. The X-ray imaging device according to claim 1, wherein the imaging device comprises a photosensitive layer containing an organic material that photoelectrically converts incident light.

4. The X-ray imaging device according to claim 3, wherein the scintillator contains a material emitting the fluorescent, and a peak wavelength of the fluorescent coincides, in a wavelength range, with a peak wavelength of a photo sensitivity of the organic material in the photosensitive layer.

5. An X-ray CT apparatus comprising:
an X-ray irradiator that irradiates a subject with an X-ray;
an X-ray imaging device according to claim 1, the X-ray imaging device being a positioned opposite to the X-ray irradiator through the subject; and
a driving unit that turns integrally the X-ray irradiator and the X-ray imaging device around the subject in such a state that the X-ray irradiator and the X-ray imaging device are opposed to each other.
